(19) United States
(12) Patent Application Publication
(10) Pub. No.: US 2012/0038155 A1
(43) Pub. Date: Feb. 16, 2012

(54) STEP UP CONVERTER FOR A WIND POWER PLANT

(76) Inventor: Mikael Bjork, Karlstad (SE)

(21) Appl. No.: 13/203,124

(22) PCT Filed: Mar. 23, 2010
(86) PCT No.: PCT/EP2010/053790

§ 371 Date: Aug. 24, 2011

(30) Foreign Application Priority Data
Mar. 25, 2009 (SE) 0950188-3

(51) Int. Cl. F03D 9/02

(52) U.S. Cl. 290/44

(57) ABSTRACT

The present invention relates to a back-up power system 200 for controlling a wind power plant in case of a power outage. The wind power plant includes one or more rotor blades. The back-up power system includes a plurality of electrical energy storage devices 204 connected in a series connection. The back-up power system also includes a DC-to-AC converter which converts DC from the plurality of electrical energy storage devices to AC and supplies the AC to an electrical motor coupled to the one or more rotor blades for controlling the pitch angle of the rotor blades. Further, the back-up power system includes a step-up DC-to-DC converter 201 coupled in series between the plurality of electrical energy storage devices and the DC-to-AC converter. The step-up DC-to-DC converter amplifies the DC voltage supplied by the plurality of electrical energy storage devices and provides the amplified DC voltage to the DC-to-AC converter.

This invention relates generally to the field of wind turbines for power generation, and more particularly, but not by way of limitation, to a system for controlling wind power plants in case of a power outage.

Among the available renewable energy sources, wind power is considered to have acquired the prime position in terms of use, along with solar power. Hence, the use of wind power plants is steadily on rise. With this the need to improve the features to effectively control the wind turbine, especially during power outages, is also gaining more and more attention.

Most of the wind power plants today use adjustable rotor blades to maximize the efficiency. While controlling the rotational speed of the rotor blades the pitch of the rotor blades are changed with respect to the direction of the wind, changing their orientation in such a way that the wind can engage the rotor blades in the most aerodynamically favorable way. Accordingly, altering the orientation of the rotor blades is also a method for decreasing the rotational speed of the rotor blades should the rotation be too fast. The pitch of the rotor blades is changed by an electrical motor coupled to the rotor blades. In order to safely control the wind power plant even during a power outage, due to failure of a power grid or due to lightning strike, a back-up power source is required to drive the electrical motor.

A solution previously in use for this problem was using hydraulic accumulators in which a non-compressible hydraulic fluid is retained under pressure from an external source. The main function of these hydraulic accumulators is to store hydraulic energy and make the energy available again to the system, i.e. the wind power plant in this case during the power outages. However, the hydraulic accumulators are quite big and bulky and hence add heavily to the maintenance costs as well as cover a lot of space. Hence, with the ever increasing size of the wind power plants the hydraulic accumulators are not a very suitable option.

Another solution in use is based on an arrangement of accumulating energy in a set of electrical energy storage devices, such as batteries and capacitors, connected in a series connection. The arrangement ensures that even in case of a power outage the power required to drive the electrical motor will be available from the set of electrical energy storage devices, which are connected to a DC-to-AC converter, converting DC from the set of electrical energy storage devices to AC, before reaching the electrical motor. However, the electrical energy storage devices are expensive, and with the larger wind power plants being built lager number of electrical energy storage devices are required to produce enough voltage to drive the electrical motor. Further, the electrical energy storage devices are sensitive to temperature fluctuations and are also unfavorable from an environmental aspect. These all again add up to the maintenance costs and the space requirement which is unwanted, especially in case of off-shore wind power plants. Accordingly there is a need for an improved back-up power source arrangement for the wind power plants.

It is an object of the invention to eliminate or at least minimize the above problems/disadvantages, which is achieved by means of the apparatus, according to the claims.

An advantage with the present invention is that less number of electrical energy storage devices is required to produce the voltage to drive an electrical motor coupled to the rotor blades of a wind power plant.

Another advantage with the present invention is that less expenditure on installation and subsequent maintenance of the electrical energy storage devices is required.

Yet another advantage with the present invention is that the space requirement for the electrical energy storage devices is less.

Another advantage with the present invention is that due to less number of electrical energy storage devices the related impacts on environment are less.

These and other objects are attained in accordance with the present invention wherein there is provided, a system for controlling a wind power plant, having at least one rotor blade, in case of a power outage. The system includes a plurality of electrical energy storage devices, wherein the plurality of electrical energy storage devices are connected in series connection, a step-up DC-to-DC converter, wherein the step-up DC-to-DC converter amplifies the voltage supplied by the plurality of electrical energy storage devices, and a motor coupled to the rotor blade for controlling the pitch angle of the rotor blade of the wind power plant. Preferably, but not necessarily, the motor is an AC motor, in which case the system also comprises a DC-to-AC converter connected in series between the DC-to-DC converter and the AC motor and the AC from the DC-to-AC converter is supplied to the AC motor.

It is understood that an AC motor according to the inventive system may be controlled by components other than a DC-to-AC converter, and that such a system will still provide the desired effect of an amplified voltage to the plurality of electrical energy storage devices.

Various objects of the present invention together with additional features contributing thereto and advantages accruing there from, will be apparent from the following description of a preferred embodiment of the invention which is shown in the accompanying drawings with like reference numerals indicating like components throughout, wherein:

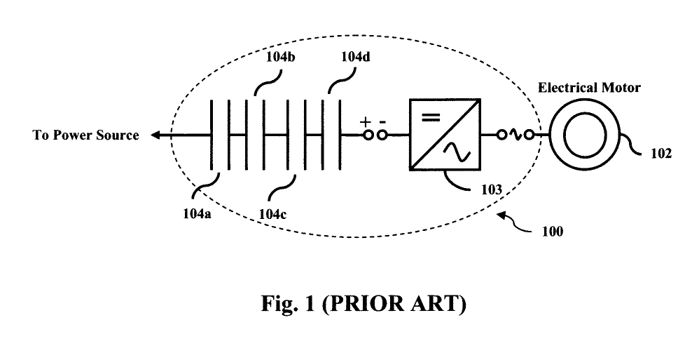

FIG. 1 is a block diagram of a back-up power system for an electrical motor coupled to the blades of a wind power plant, according to the prior art, and

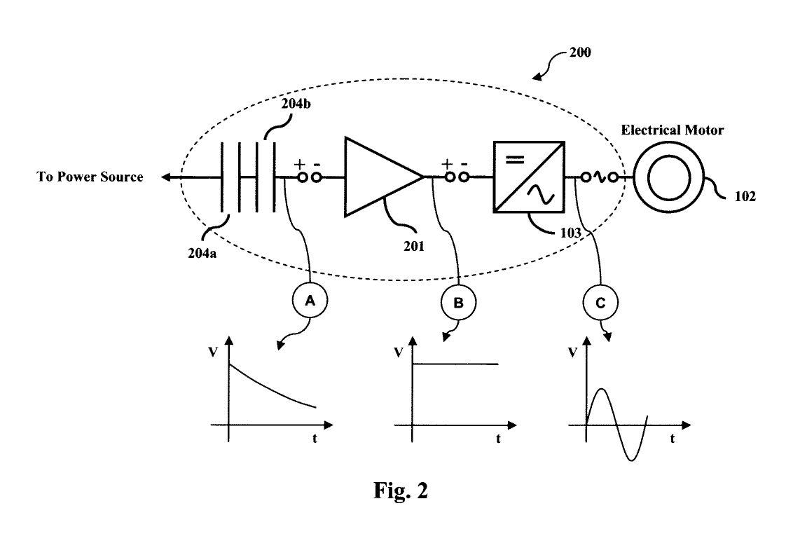

FIG. 2 is a block diagram of a back-up power system for an electrical motor coupled to the blades of the wind power plant, according to a preferred embodiment of the present invention.

Various embodiments are described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiments may be practiced without these specific details.

FIG. 1 is a block diagram of a back-up power system 100 for an electrical motor 102 coupled to the blades of the wind power plant, according to the prior art. The back-up power system 100 includes a plurality of electrical energy storage devices 104a, 104b, 104c, 104d and a DC-to-AC converter 103, wherein the DC-to-AC converter 103 converts DC provided by the plurality of electrical energy storage devices 104a, 104b, 104c, 104d to AC before providing it to the electrical motor 102 in the case of a power outage due to failure of a power grid or lightning. The plurality of electrical energy storage devices 104a, 104b, 104c, 104d can be charged using power from a power grid or using a part of the power generated by the wind power plant.

FIG. 2 is a block diagram of a back-up power system 200 for the electrical motor 102 coupled to the rotor blades of the wind power plant, according to a preferred embodiment of the present invention. The back-up power system 200 includes a plurality of electrical energy storage devices 204a, 204b, a step-up DC-to-DC converter 201, wherein the step-up DC-to-DC converter 201 amplifies the voltage supplied by the plurality of electrical energy storage devices 204a, 204b, and a DC-to-AC converter 103, wherein the DC-to-AC converter 103 converts the amplified DC voltage provided by the plurality of electrical energy storage devices 204a, 204b to AC voltage before providing it to the electrical motor 102 in the case of a power outage due to failure of a power grid or lightning. In an embodiment, the electrical energy storage devices 204a, 204b are capacitors. In another embodiment, the electrical energy storage devices 204a, 204b are batteries.

During normal operation of the wind power plant the electrical motor 102 receives power directly from a power grid for controlling the pitch angle of the rotor blades. In the meantime, the plurality of electrical energy storage devices 204a, 204b in the back-up power system 200 get charged using power from a power grid or using a part of the power generated by the wind power plant. On occurrence of a power outage the electrical motor 102 stops receiving power from the power grid, however, at the same time the electrical motor 102 needs to be operated to control the pitch angle of the rotor blades to slow down the rotational speed of the rotor blades and bring the wind power plant to a halt. This is necessary for safety and maintenance of the wind power plant until the time supply of power from the power grid is resumed, or the turbine has been stopped to a safe mode. In this case, the plurality of electrical energy storage devices 204a, 204b provides power to the electrical motor 102 to control the rotor blades. However, the electrical motor 102 preferably being an AC motor, the DC voltage provided by the plurality of electrical energy storage devices 204a, 204b is, first amplified using the step-up DC-to-DC converter 201 and then passed through the DC-to-AC converter 103 to convert the amplified DC voltage into AC voltage.

The advantages of using the step-up DC-to-DC converter 201 can be detailed with the help of FIG. 2. At point A, as can be seen from the graph of Voltage Output from the plurality of electrical energy storage devices 204a, 204b versus time, the output voltage decreases with passes of time as the electrical charge stored in the plurality of electrical energy storage devices 204a, 204b is spent. In turn, in absence of the step-up DC-to-DC converter 201, the output voltage provided by the DC-to-AC converter 103 to the electrical motor 102, as can be seen from the graph at point C, would gradually diminish over time and the wind power plant may not be stopped in a proper manner due to insufficient supply of power to control the electrical motor 102. Hence, one way to solve this problem could be using a large number of electrical energy storage devices to provide power to the electrical motor 102 for sufficient time to bring the wind power plant to a halt. Another way could be using the step-up DC-to-DC converter 201 which can, as can be seen from the graph at point B of Voltage Output from the step-up DC-to-DC converter 201 versus time, amplify the output voltage from the plurality of electrical energy storage devices 204a, 204b to provide a steady amplified voltage over time, as depicted by a straight line in the graph. It is noteworthy that due to using the step-up DC-to-DC converter 201 the number of electrical energy storage devices in the back-up power system 200, required to provide sufficient power to operate the electrical motor 102, decreases in comparison to the number of electrical energy storage devices required in the back-up power system 100.

Accordingly, the inventive back-up power system 200 described herein provides various advantages over the prior art. An advantage offered is that due to presence of the step-up DC-to-DC converter 201 less number of electrical energy storage devices is required to produce the required voltage to drive the electrical motor 102. Further, due to requirement of a smaller number of electrical energy storage devices less expenditure on installation and subsequent maintenance of the electrical energy storage devices is required. Moreover, the smaller number of electrical energy storage devices also ensure requirement of less space, further adding up to the savings and minimizing the related impacts on the environment.

1-6. (canceled)

7. A back-up power system for controlling a wind power plant in case of a power outage, wherein the wind power plant comprises at least one rotor blade, the system comprising:
a plurality of electrical energy storage devices, the plurality of electrical energy storage devices being connected in a series connection;
a motor coupled to the at least one rotor blade, wherein current from the plurality of electrical energy storage devices is supplied to the motor for controlling a pitch angle of the at least one rotor blade of the wind power plant, and wherein the motor may be either a DC or an AC motor; and
a step-up DC-to-DC converter coupled in series between the plurality of electrical energy storage devices and the motor, wherein the step-up DC-to-DC converter amplifies the voltage supplied by the plurality of electrical energy storage devices.

8. The back-up power system according to claim 7, wherein the motor is an AC motor, and wherein the system comprises a DC-to-AC converter which converts DC from the electrical energy storage devices to AC, wherein the AC from the DC-to-AC converter is supplied to the AC motor.

9. The back-up power system according to claim 8, wherein the step-up DC-to-DC converter is coupled in series between the plurality of electrical energy storage devices and the DC-to-AC converter.

10. The back-up power system according to claim 7, wherein the plurality of electrical energy storage devices are charged using power from a power grid.

11. The back-up power system according to claim 7, wherein the plurality of electrical energy storage devices are charged using power generated by the wind power plant.

12. The back-up power system according to claim 7, wherein the step-up DC-to-DC converter is configured to provide sufficient power to drive the motor.
